(19) United States
(12) Patent Application Publication
(10) Pub. No.: US 2007/0162908 A1
(43) Pub. Date: Jul. 12, 2007

(54) Behavior-based resource capacity adjustment method for business processes

(75) Inventors: Thomas D. Erickson, Minneapolis, MN (US); Brent Tzion Hailpern, Katonah, NY (US); Wendy Anne Kellogg, Yorktown Heights, NY (US); Peter Kenneth Malkin, Ardsley, NY (US)

Correspondence Address: MICHAEL J. BUCHENHORNER, 8540 S.W. 83 STREET, MIAMI, FL, 33143, US

(73) Assignee: International Business Machines Corporation

(21) Appl. No.: 11/327,038

(22) Filed: Jan. 6, 2006

(51) Int. Cl. G06F 9/46

(52) U.S. Cl. 718/104

(57) ABSTRACT

According to an embodiment of the invention, a method includes steps of deriving a process-based resource adjustment model for the process; monitoring the process for the number of users using each of steps of the process at time t₀; calculating the number of users that will using each of the process steps at time t₁, which is later than time t₀; determining the resources required to serve the process at time t₁; and adjusting the resources as appropriate to ensure adequate capacity, this adjustment completed by time t₁. Other embodiments include a computer program product and an information processing system configure for performing the process.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of information processing systems, and more particularly relates to the field of managing use of a scare resource.

### BACKGROUND OF THE INVENTION

Telephone companies charge more for calls during business hours, e.g., nine to five o'clock, than evenings. Electric utilities charge more for power during summer days when air conditions work harder, than during the cooler evenings. These pricing variations represent attempts to balance the use of resources in the face of anticipated demands. It is important to note that one reason that demand can be anticipated, and mapped to particular times of day, is that the usage of resources is shaped by local conditions. That is, both phone companies and electric utilities operate in geographically circumscribed regions which embrace a few time zones and (for seasonal effects) only one hemisphere, and thus predicted resource demands can be mapped to time and date.

However, more and more, systems, many of which draw upon various resources to function effectively, are global in their reach. As their reach extends, they lose the local constraints which decrease the abilities of their custodians to predict resource demands as a function of time and other local constraints. Yet, the ability to cope with varying levels of demand for scarce resources remains. Prior approaches have included network and server load determination approaches but these are unable to predict future load levels. A method for determining which users of an email server to remove when it is overloaded but are also unable to predict future load problems. A web server that “batted” incoming requests for web pages to a variety of sub-web servers to balance load for a high-volume website but this is also unable to predict and send notifications of future load problems. Usage analysis, e.g. web log load predictors, can provide indications of future resource requirements using historical data, but are not to pinpoint the process causing the load; i.e., what users will be doing, but not why. Therefore, there is a need for a method and system that overcomes the above shortcomings of the prior art.

### SUMMARY OF THE INVENTION

Briefly, according to an embodiment of the invention, a method comprises steps of deriving a process-based resource adjustment model for the process; monitoring the process for the number of users using each of steps of the process at time t₀; calculating the number of users that will using each of the process steps at time t₁, which is later than time t₀; determining the resources required to serve the process at time t₁; and adjusting the resources as appropriate to ensure adequate capacity, this adjustment completed by time t₁. Other embodiments include a computer program product and an information processing system configure for performing the process.

### BRIEF DESCRIPTION OF THE DRAWINGS

FIG. 1 is a flowchart of a method according to an embodiment of the invention.

FIG. 2 is a high level block diagram showing an information processing system according to another embodiment of the invention.

### DETAILED DESCRIPTION

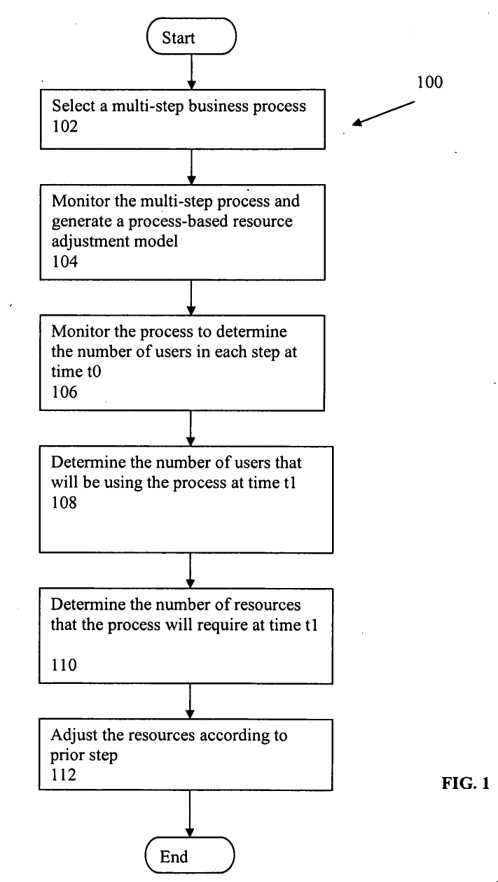

Referring to FIG. 1, there is shown a flowchart of a method 100 according to an embodiment of the invention. First, in step 102 we identify and select a multi-step business process. Some business processes are defined by the business (e.g., travel expense accounting, asset management, etc.). Others might be induced from empirical observation of usage patterns (e.g., website access patterns). But whether defined or induced, the first step 102 is to select a multi-step business process for handling. The process-based resource adjustment model may include a temporal usage component that enables the calculation of how many users will be at subsequent steps in the process at some future time, given a number of users in a prior step of the business process.

In step 104 we monitor the multi-step business process, and through that monitoring generate a process-based resource adjustment model that has three parts: a temporal usage component, a capacity requirements component, and a capacity adjustment temporal component. The temporal usage component calculates how many people will be at subsequent steps in the process at some future time, given a number of people in a prior part of the business process. The capacity requirements component calculates how much resource capacity is required to support a step in the process given the number of people in that step. The capacity adjustment temporal component calculates how long it takes to bring the required amount of resource online to support a process (and how long it takes to release unneeded resources), given a current level of resource capacity. The process-based resource adjustment model may include a temporal usage component that enables the calculation of how many users will be at subsequent steps in the process at some future time, given a number of users in a prior step of the business process. The process-based resource adjustment model may include a capacity requirements component that enables the calculation of how much resource capacity is required to support a step in the process given the number of people in that step. The process-based resource adjustment model may also include a capacity adjustment temporal component that enables the calculation of how long it takes to bring the required amount of resource online to support a process and how long it takes to release unneeded resources, given a current level of resource capacity.

Given the process and its corresponding process-based resource adjustment model, the method's adjustment method proceeds as follows. In step 106, the process is monitored to determine the number of users in each of its steps. This is done at a time t₀. We recruit or release resources as appropriate to ensure adequate but not excessive capacity. Note that the adjustment calculation is based not merely on the activity of each of the users, but on which process step they are executing.

In step 108 the number of users that will be using the process steps at time t₁ is determined. In step 110 the method 100 determines the resources required to perform the process steps at time t1. Then, in step 112 the method adjusts the resources as appropriate to ensure the adequate, but not excessive, capacity by time t₁.

The method 100 can further comprise the steps of determining the amount of resources required to serve the process at time t1 and sending an early warning notification if there are insufficient resources for time t1. The method 100 can further comprise the step of continuing execution with the step of monitoring so as to provide continual process-based resource adjustment. The adjusting step 112 can also include changing the usage cost so as to slow or reduce the number of users. The method 100 can further comprise determining a maximum number of users that can employ a given set of resources to execute a given process. The method 100 can further support two or more processes running concurrently on a given set of resources. The method 100 can further comprise the steps of determining the terms of a service level agreement, and dictating the level of service a given set of resources will provide for a given number of users running one or more modeled processes.

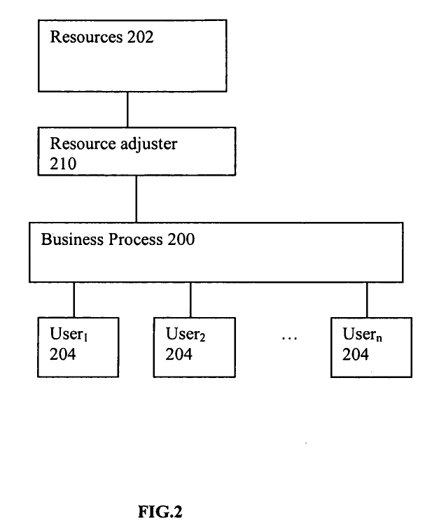

Referring to FIG. 2, there is shown a high level block diagram showing an information processing system according to another embodiment of the invention. The system includes a business process 200 which is connected to a plurality of resources 202 and a plurality of users 204-208. A resource adjuster 210 adjusts the number of resources according to the number of users 204. The invention can also be implemented as a computer program product configured to perform the process 100.

As our example, consider a company that operates an e-commerce web site that is engaged in selling vitamins. The basic business model is that customers create a personal account, fill out a health assessment, and receive recommendations about vitamins that will best meet their needs, which they can then purchase. Vitamins are supplied on a monthly basis, and customers also receive newsletters that give advice about exercise and diet regimens tailored to their needs.

Customers who decide they are interested in purchasing vitamins go through a four step process:

(1) they create their own personal account;

(2) they take an assessment, in which they answer some questions about their health and medical history, which they then submit;

(3) they are provided with a recommendation for the vitamins that will be suit their needs, and

(4) they may place an order either:
(4a) by typing information into an online form and submitting it, or
(4b) by using voice chat to talk with an operator.

Because the company has been in business for a while, they have a fairly good understanding of the dynamics of their business process. In particular, they know three things:

1. The relative number of customers who complete each step:

If N people create an account in step 1, 0.8 N will complete the assessment, 0.8N will look at the recommendation, and 0.5 N will proceed to place an order. Of those who place an order 80% (0.4 N) will use the web, and 20% (0.1 N) will use the toll free number.
   2. The average time spent per step:
Time to create an account is an average of 1 minute; time to take the assessment is an average of 5 minutes; time spent looking over the assessment is an average of 2 minutes; and time spent placing an order is 3 minutes (if done online) or 5 minutes (if done by voice chat (assuming that an operator is immediately available).
   3. The resources required to support each step

Steps 1-3 require one or more servers to support the textual interaction with a customer; however they are not especially resource intensive. Step 4a requires credit card verification, and step 4b is especially resource intensive in that it requires a human operator to interact with each person. For each case, the company is able to estimate how much of each resources is needed to handle a given number of people, and furthermore, how long it will take to bring more of the resource online (e.g. quick in the case of adding servers, not so quick in the case of bringing on more operators).

On March 13th, at about 3:27 pm ET, the number of people accessing the company's web site doubled, and then quadrupled over the next two minutes. Fortunately, the company subscribed to the RCA (Resource Capacity Adjustment) service, which went into action. Using models based on the information noted in the previous paragraph, RCA quickly brought extra servers online to handle the extra load for steps 1 through 3 and 4a. For step 4b, it sent an alert to the call center with a notification of the need for extra operators when the surge of customers entered that step in 8 minutes. Because its model of resource recruitment for operators indicated that there were not enough operators on call to handle the surge, it also adjusted step 4 to offer prospective buyers a discount if they used the self-service step (4a), rather than talking to an operator.

The web site traffic peeked at 6 times the normal rate after 15 minutes (it was later discovered that the company had been mentioned on a popular call-in radio show). RCA successfully supported the traffic spike by adding servers (and later releasing them as traffic declined); additional operators were also brought online smoothly, although a significant discount (dynamically adjusted over time) had to be offered to divert enough potential callers to the self-purchase step to avoid overwhelming the call center.

Therefore, while there has been described what is presently considered to be the preferred embodiment, it will understood by those skilled in the art that other modifications can be made within the spirit of the invention.

What is claimed is:

1. A method of adjusting resources for serving a given multi-step business process based on process-based state information, the method comprising steps of:
deriving a process-based resource adjustment model for the process;
monitoring the process for the number of users using each of steps of the process at time t₀;
calculating the number of users that will be using each of the process steps at time t₁, which is later than time t₀;
determining the resources required to serve the process at time t₁; and
adjusting the resources as appropriate to ensure adequate capacity, this adjustment completed by time t₁.

2. The method of claim 1, further comprising the steps of determining the amount of resources required to serve the process at time t₁ of sending an early warning notification if there are insufficient resources for time t₁.

3. The method of claim 1, wherein the process-based resource adjustment model includes a temporal usage component that enables the calculation of how many users will be at subsequent steps in the process at some future time, given a number of users in a prior step of the business process.

4. The method of claim 1, wherein the process-based resource adjustment model includes a capacity requirements component that enables the calculation of how much resource capacity is required to support a step in the process given the number of people in that step.

5. The method of claim 1, wherein the process-based resource adjustment model includes a capacity adjustment temporal component that enables the calculation of how long it takes to bring the required amount of resource online to support a process and how long it takes to release unneeded resources, given a current level of resource capacity.

6. The method of claim 1, wherein the step of determining the resources required to serve the process at time t₁ also determines the time required to install these resources.

7. The method of claim 1, wherein the step of determining the number of users at time t₁ also determines the cost of each resource, as well as the cost of adding or deleting the resource.

8. The method of claim 1, wherein the step of adjusting the resources includes recruiting or releasing resources.

9. The method of claim 1, further comprising the step of continuing execution with the step of monitoring so as to provide continual process-based resource adjustment.

10. The method of claim 1, wherein the adjusting includes changing the usage cost so as to slow or reduce the number of users.

11. The method of claim 10 wherein the method can be used to determine whether or not a given process can be provided by a given set of resources.

12. The method of claim 10, further comprising determining a maximum number of users that can employ a given set or resources to execute a given process.

13. The method of claim 1 wherein the method comprises supporting two or more processes running concurrently on a given set of resources.

14. The method of claim 1, further comprising using the process to determine the terms of a service level agreement, and dictating the level of service a given set of resources will pervade for a given number of users running one or more modeled processes.

15. The method of claim 1, wherein a first set of users provides the current process-based resource adjustment invention so that a second set of users can execute a given process using minimal resources.

16. The method of claim 1, wherein a first set of users specify the minimum set of resources that will be required for a second set of users to execute a given process.

17. The method of claim 1, wherein a first set of users can determine the process-based resource adjustment model for a second set of user with respect to a given process.

18. A computer readable medium comprising program code for deriving a process-based resource adjustment model for the process;
monitoring the process for the number of users using each of steps of the process at time t₀;
calculating the number of users that will using each of the process steps at time t1, which is later than time t₀;
determining the resources required to serve the process at time t₁; and
adjusting the resources as appropriate to ensure adequate capacity, this adjustment completed by time t₁.

19. An information processing system comprising:
a processor configured for deriving a process-based resource adjustment model for the process; monitoring the process for the number of users using each of steps of the process at time t₀; calculating the number of users that will using each of the process steps at time t1, which is later than time t₀; determining the resources required to serve the process at time t₁; and adjusting the resources as appropriate to ensure adequate capacity, this adjustment completed by time t₁.
